(19) United States
(12) Patent Application Publication
(10) Pub. No.: US 2013/0038697 A1
(43) Pub. Date: Feb. 14, 2013

(54) WIRELESS COMMUNICATION DEVICE WITH DUAL IMAGING UNITS

(71) Applicant: YEN-CHUN CHEN, Tu-Cheng (TW)

(72) Inventor: YEN-CHUN CHEN, Tu-Cheng (TW)

(73) Assignee: HON HAI PRECISION INDUSTRY CO., LTD., Tu-Cheng (TW)

(21) Appl. No.: 13/523,893

(22) Filed: Jun. 15, 2012

(30) Foreign Application Priority Data
Aug. 9, 2011 (TW) 100128333

(51) Int. Cl. H04N 13/02

(52) U.S. Cl. 348/47; 348/E13.074

(57) ABSTRACT

A mobile phone includes a shell and a camera module received in the shell. The shell has a first surface and a second surface opposite to the first surface. The first surface defines a first opening. The second surface defines a second opening and a third opening. The camera module includes a first imaging unit, a second imaging unit, and an image processor. The first imaging unit is aligned with the first opening or the second opening, to obtain a first image of an object. The second imaging unit is aligned with the third opening to obtain a second image of the object. When the first imaging unit faces the second opening, the image processor processes the first image and the second image to form a three-dimension image.

### BACKGROUND

1. Technical Field

The present disclosure relates to wireless communication devices and, particularly, to a wireless communication device with dual imaging units.

2. Description of Related Art

Many wireless communication devices, which can capture three-dimension images have at least two imaging units. The two imaging units are used for capturing two images of an object from different views, and thus an image processor can produce a three-dimension image using the two images. However, the two imaging units are generally positioned on a rear of the wireless communication device and cannot be used to capture an image of the user who holds the wireless communication device in a video call. Thus, the mobile phone must employ an additional imaging unit in a front of the wireless communication device to capture the image of the user. Therefore, with the addition of the second imaging device, the mobile phone becomes expensive.

Therefore, it is desirable to provide a wireless communication device that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic front view of a wireless communication device, according to a first embodiment.

FIG. 2 is a schematic back view of the wireless communication device of FIG. 1.

FIG. 3 is a schematic view of a camera module of the wireless communication device of FIG. 1 in a first working state, wherein a first imaging unit and a second imaging unit of the camera module both toward a same direction.

FIG. 4 is a schematic view of a camera module of the wireless communication device of FIG. 1 in a second working state, wherein the first imaging unit and the second imaging unit face different directions.

FIG. 5 is a schematic front view of a wireless communication device, according to a second embodiment.

FIG. 6 is a schematic back view of the wireless communication device of FIG. 5.

FIG. 7 is a schematic view of a camera module of the wireless communication device of FIG. 5 in a first working state, wherein a first imaging unit and a second imaging unit of the camera module both face a same direction.

### DETAILED DESCRIPTION

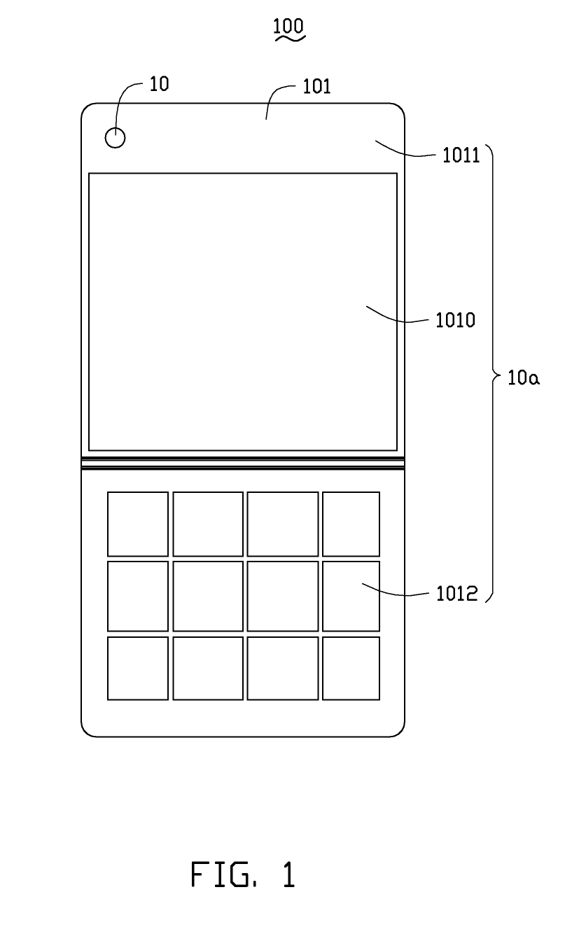

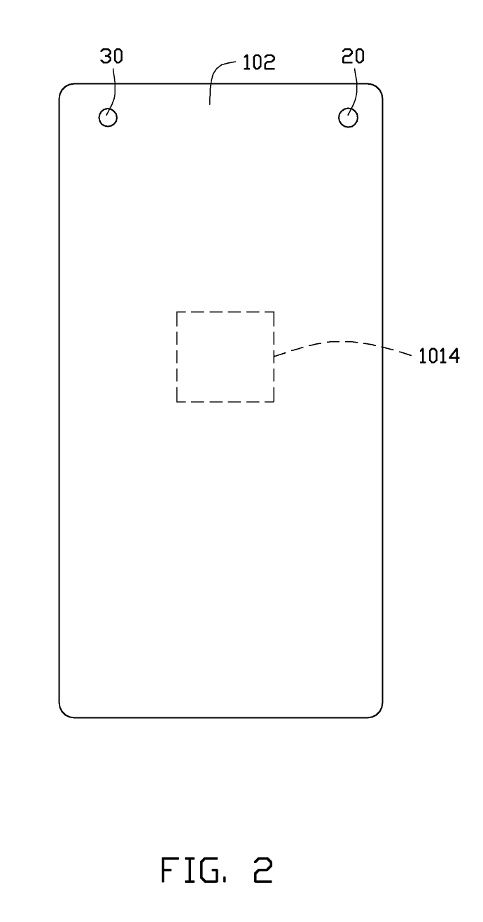

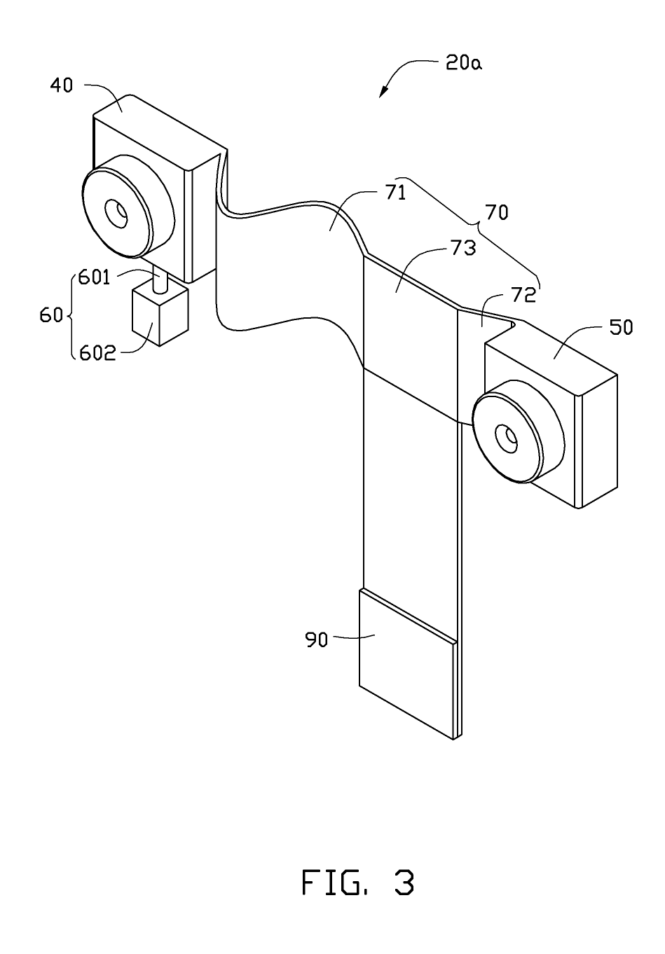

FIGS. 1-3, illustrate a wireless communication device 100 according to a first embodiment. The wireless communication device 100 includes a main body 10a and a camera module 20a. In this embodiment, the wireless communication device 100 is a mobile phone.

The main body 10a includes a shell 1011, a keyboard 1012, a display screen 1010, and a central processing unit (CPU) 1014. The shell 1011 includes a first surface 101 and a second surface 102 opposite to the first surface 101. In this embodiment, the first surface 101 faces a user when the mobile phone 100 is used. The keyboard 1012 and the displaying screen 1010 are positioned on the first surface 101. In other embodiments, the keyboard 1012 can be omitted.

The CPU 1014 is received in the shell 1011 and is electrically connected to the keyboard 1012 and the displaying screen 1010. The CPU 1014 controls the keyboard 1012 and the display screen 1010.

The shell 1011 defines a first opening 10, a second opening 20, and a third opening 30 for allowing light rays to pass respectively. In this embodiment, the first opening 10 is positioned on an upper-left corner of the first surface 101, the second opening 20 is positioned on an upper-right corner of the second surface 102, and the third opening 30 is positioned on an upper-left corner of the second surface 102. In this embodiment, the second opening 20 is coaxial with the first opening 10, and shares a horizontal line with the third opening 30. The positions of the first opening 10, the second opening 20, and the third opening 30 are not limited to this embodiment.

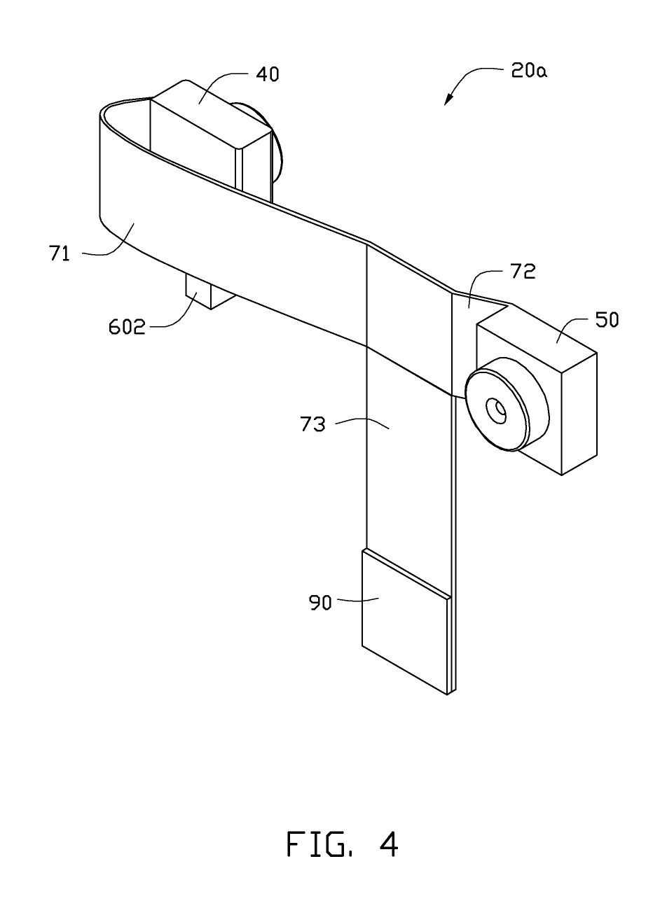

FIGS. 4, illustrate the camera module 20a is received in the shell 1011. The camera module 20a includes a first imaging unit 40, a second imaging unit 50, a first driving module 60, a flexible printed circuit board (FPCB) 70, and an image processor 90.

The first driving module 60 drives the first imaging unit 40 to rotate, and thus allowing the first imaging unit 40 to be aligned with the first opening 10 or the second opening 20 alternatively. The first driving module 60 includes a rotating shaft 601 and a motor 602. The rotating shaft 601 is connected to the first imaging unit 40. A center axis of the rotating shaft 601 is perpendicular to an optical axial of the first imaging unit 40. The motor 602 drives the rotating shaft 601 to rotate around itself. The configuration of the first driving module 60 is not limited to this embodiment.

When the first image unit 40 faces the second opening 20, the first imaging unit 40 and the second imaging unit 50 capture two images of an object from different views.

The FPCB 70 sends two image signals corresponding to the two images to the image processor 90. And the FPCB 70 includes a first portion 71, a second portion 72, and a third portion 73. The third portion 73 is interconnected to the first portion 71 and the second portion 72. The first portion 71 is electrically connected to the first imaging unit 40. The second portion 72 is electrically connected to the second imaging unit 50. The third portion 73 is electrically connected to the image processor 90.

The image processor 90 processes the two image signals from the FPCB 70, and thus producing a three-dimension image signal. The image processor 90 is further electrically connected to the CPU 1014. The CPU 1014 controls the displaying screen 1010 to display a three-dimension image corresponding to the three-dimension image signal.

In use, when a user wants to capture a three-dimension image, the first driving module 60 drives the first imaging unit 40 to face the second opening 20, and thus the first imaging unit 40 and the second imaging unit 50 capture the two images of the object. The FPCB 70 sends two image signals corresponding to the two images to the image processor 90. The image processor 90 processes the two image signals to produce the three-dimension image. When the user wants to have a video call with others, the first driving module 60 drives the first imaging unit 40 to face the first opening 10, and thus the first imaging unit 40 can capture an image of the user, and at the same time, the second imaging unit 50 still captures an image of outside scenes surrounding the user, or the second imaging unit 50 can be controlled by the CPU 1014 to stop working.

For the first imaging unit 40 being rotated conveniently, the length of the first portion 71 is longer than that of the length of the second portion 72.

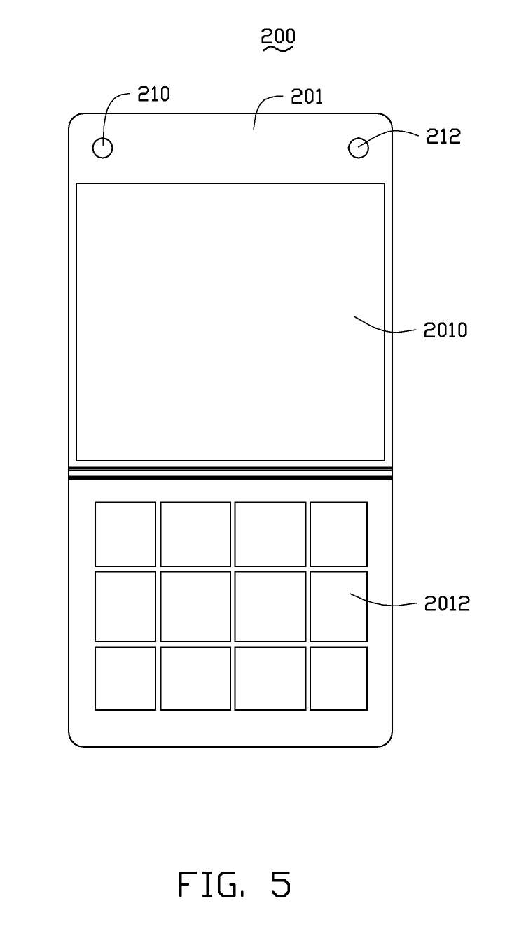

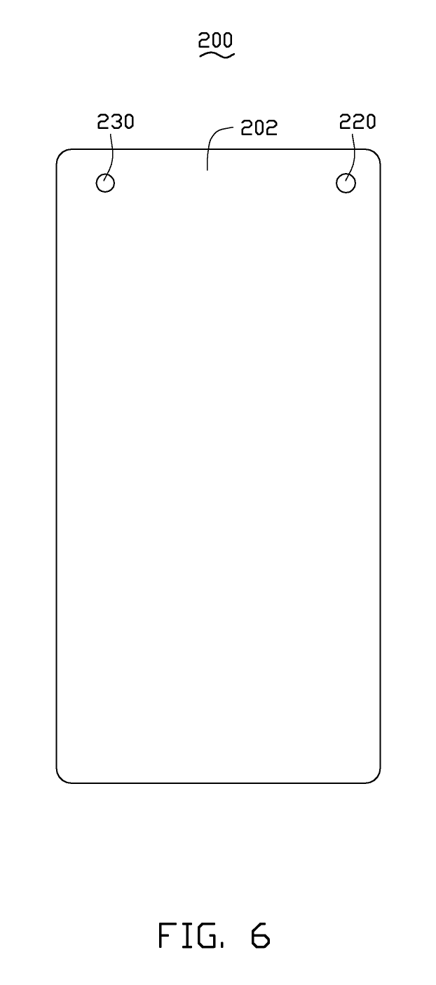

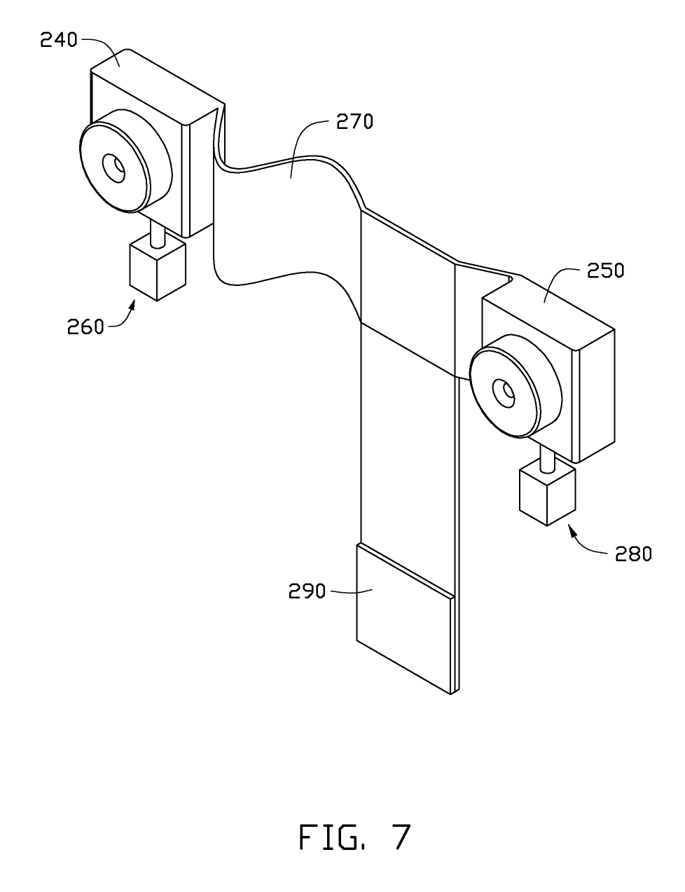

FIGS. 5-7, illustrate a mobile phone 200 of a second embodiment. The mobile phone 200 includes a first imaging unit 240, a second imaging unit 250, a first driving module 260, a FPCB 270, an image processor 290, a displaying screen 2010, and a keyboard 2012 which are substantially the same as those of the first embodiment respectively. The mobile phone 200 has a first surface 201 facing the user and a second surface 202 opposite to the first surface 201. The first surface 201 defines a first opening 210, the second surface 202 defines a second opening 220 and a third opening 230.

The main difference between the mobile phone 200 and the first mobile phone 100 is that the shell 2011 further has a fourth opening 212 on an upper-right corner of the first surface 201, and the mobile phone 200 further has a second driving module 280 for driving the second imaging unit 250 to rotate. The fourth opening 212 shares a same horizontal line with the first opening 210, and is coaxial with the third opening 230. The second imaging unit 250 can be driven by the second driving module 280 to be aligned with the third opening 230 or the fourth opening 212 alternatively. The position of the fourth opening 212 is not limited to this embodiment. In this embodiment, the configuration of the second driving module 280 is substantially the same as that of the first driving module 260. The configuration of the second driving module 280 is not limited to this embodiment.

When the first imaging unit 240 faces the first opening 210, and the second imaging unit 250 faces the fourth opening 212, the first imaging unit 240 and the second imaging unit 250 can capture two images of a first object on the side of the user, and thus the image processor 290 can obtain a first three-dimension image of the first object. When the first imaging unit 240 faces the second opening 220, and the second imaging unit 250 faces the third opening 230, the first imaging unit 240 and the second imaging unit 250 can capture two images of a second object on a side opposite to the user, and thus the image processor 290 can obtain a second three-dimension image of the second object.

The mobile phone uses only two camera modules to capture three-dimension image and also can capture an image of the user in a video call. This reduces cost of the mobile phone.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A mobile phone, comprising:
a shell having a first surface and a second surface opposite to the first surface, wherein the first surface defines a first opening, the second surface defines a second opening and a third opening; and
a camera module received in the shell and comprising:
a first imaging unit capable of being rotated to aligned with the first opening or the second opening;
a second imaging unit aligned with the third opening;
an image processor;
Wherein when the first imaging unit faces the second opening, the first imaging unit and the second imaging unit face a same direction, the first imaging unit captures an object to obtain a first image, the second imaging unit captures the object to obtain a second image, the first image and the second image are sent to the image processor, the image processor processes the first image and the second image to form a three-dimension image.

2. The mobile phone of claim 1, further comprising a first driving module connected to the first imaging unit and configure for rotating the first imaging unit to face the first opening or the second opening.

3. The mobile phone of claim 2, wherein the first driving module comprises a rotating shaft and a rotating motor, the rotating shaft is connected to the first imaging unit, the rotating motor is configured for driving the rotating shaft to rotate.

4. The mobile phone of claim 3, wherein an extending direction of the rotating shaft is perpendicular to an optical axis of the first imaging unit.

5. The mobile phone of claim 1, wherein the first opening is coaxial with the second opening.

6. The mobile phone of claim 1, wherein the second surface comprises two upper corners, the second opening is positioned on one of the two upper corners; the third opening is positioned on the other upper corner.

7. The mobile phone of claim 6, comprising a flexible printed circuit board electrically connected to the first imaging unit, the second imaging unit, and the image processor, the flexible printed circuit board is configured for sending two image signals corresponding to the two images of the object to the image processor.

8. The mobile phone of claim 7, wherein the flexible printed circuit board comprises a first portion, a second portion, and a third portion, the third portion is interconnected to the first portion and the second portion, the first portion is electrically connected to the first imaging unit, the second portion is electrically connected to the second imaging unit, the third portion is electrically connected to the image processor.

9. The mobile phone of claim 8, wherein a length of the first portion is longer than a length of the second portion.

10. The mobile phone of claim 1, comprising a central processing unit and a displaying screen, the central processing unit electrically connected to the image processor and the displaying screen and configured for controlling the displaying screen to display the three-dimension image.

11. The mobile phone of claim 1, wherein the first surface defines a fourth opening, the fourth opening is coaxial with the third opening, the second imaging unit is capable of being selectively rotated to be aligned with the third opening or the fourth opening.

12. The mobile phone of claim 10, wherein the mobile phone further comprises a second driving module connected to the second imaging unit and configured for driving the second imaging unit to rotate.
